(19) United States
(12) Patent Application Publication
(10) Pub. No.: US 2004/0237262 A1
(43) Pub. Date: Dec. 2, 2004

(54) Wearable holder for pens and the like

(76) Inventor: James Serafino Arnone, Kenmore, NY (US)

Correspondence Address: JAMES S. ARNONE, P. O. BOX 1771, BUFFALO, NY, 14240-1771, US

(21) Appl. No.: 10/878,587

(22) Filed: Jun. 28, 2004

Related U.S. Application Data
(63) Continuation-in-part of application No. 10/356,821, filed on Feb. 3, 2003, now abandoned.

(51) Int. Cl. B43K 25/00

(52) U.S. Cl. 24/10 R

(57) ABSTRACT

A wearable holder for a writing instrument, such as a pen, pencil or the like comprises a slidable clip member adapted to attach to a user's clothing, and a writing instrument holding means for releasably holding a pen or the like, secured to the slidable clip member. The writing instrument holding means is rotatably secured to the outer face of the slidable clip member by means of a freely turning shaft, such as a rivet or a nut and bolt assembly. In use, the slidable clip member may be attached to the user's clothing in various orientations, for example, horizontally or vertically or other, and the freely turning shaft will allow the writing instrument to hang vertically. The writing instrument holding means may be a generally hollow open-ended cylindrical member made of a resilient material, with a longitudinal slit to allow a writing instrument to be inserted and removed. As a Separate option, the holding means may be a hook or loop material or a magnetic material, which is used in conjunction with a writing instrument that has a mating material attached to its barrel.

### BACKGROUND OF THE INVENTION

1. Field of the Invention

The present invention relates to devices for holding writing instruments such as pens, pencils and the like and in particular to a holder for such instruments adapted to be worn by the user.

2. Background and Prior Art

Many work or study situations necessitate the frequent taking of notes, recording of information, etc., thus requiring intermittent use of a writing instrument, typically a pen or pencil. To facilitate such use, various devices are employed to hold a writing instrument near a place of use, such as a desk, telephone, or the like. However, a mobile user, such as a student, deliveryman, shipping clerk, or other, is typically required to carry a writing instrument with him or her. Commonly this is accomplished by using a pen or pencil having a clip thereon that can be clipped into the pocket of a shirt. However, such use has limitations. Not all writing instruments are equipped with clips. Furthermore, not all clothing includes pockets or other suitable places for holding a writing instrument having a built-in clip. Thus, there is a need for a device and/or method that will permit a user to conveniently attach a writing instrument to an article of clothing or the like. The need has been recognized for more than one hundred years. In U.S. Pat. No. 301,133, issued in 1884 to Lilley et al there is disclosed a combined pencil, eyeglass, ticket and bouquet holder that can be pinned to a user's garment. U.S. Pat. No. 576,903 issued in 1897 to Sharp discloses a pencil holder that can be attached to a user's garment by means of a pin. U.S. Pat. No. 1,170,601 to Bliemeister discloses a combined badge and pencil holder that further includes a pin for attaching to a user's garment.

U.S. Pat. No. 1,623,966 to McCaskill discloses a pen and pencil holder wherein a small rectangular plate is adapted on one side with a pin to be pinned to a garment and on the other side to receive and hold a pen and/or pencil with the aid of the spring clips of the pen and/or pencil.

U.S. Pat. No. 3,387,341 to Mates et al discloses a fastening device for releasably securing an implement or instrument, such as a writing instrument, to a supporting surface. The writing instrument is removably held within a resilient tubular member configured for force fitting the instrument into the tubular member. The tubular member in turn is releasably secured to the supporting surface by a hook and loop attachment.

U.S. Pat. No. 3,983,602 to Barry discloses a one piece molded plastic holder adapted to detachably mount on a safety helmet and to removably hold an instrument, such as a pen or pencil.

U.S. Pat. No. 4,214,688 to Griffin is directed to a tool mounting assembly comprising a clip member for holding a tool such as a flashlight attached to a mounting clip which in turn may be clipped to a belt or pocket.

U.S. Pat. No. 4,674,298 to Wimmershoff-caplan discloses an ornamental pendant necklace assembly adapted to disengageably hold a writing implement.

U.S. Pat. No. 5,140,723 to Genzel discloses a wearable pen and/or pencil holder comprising a plate having attached thereto adjustable clips for holding the pen and/or pencil. The plate is designed to be worn as a pin on an article of clothing or to be attached to a necklace or chain, or worn as a bracelet or attached to an object, such as a book.

U.S. Pat. No. 5,544,396 to Mekyska discloses a holder for writing utensils or the like wherein the utensil(s) is held between two movable clamp jaws. The holder is adapted to be mounted on workplace surfaces for example by adhesive or various fastening means.

### BRIEF SUMMARY OF THE INVENTION

It is a primary object of the present invention to provide a holder for writing instruments or the like that may be conveniently attached to a user's clothing.

It is a further object to provide a wearable holder for a writing instrument that may be attached to a user's belt, shirt, or other article of clothing or other surface in various orientations.

It is a still further object to provide a wearable holder for a writing instrument, such as a pen, adapted for attachment to a user's article of clothing wherein the instrument may freely rotate to a vertical position regardless of the orientation of the holder.

It is a further object to provide a device that will allow a writing instrument such as a pen to be worn or carried on a user's shirt or other article of clothing without the need for a “pen clip” or a shirt pocket and can be easily secured or removed with one hand.

It is a further object to provide a wearable holder for a writing instrument that can be worn on a lanyard, cord, chain or the like in a pendant fashion around the user's neck.

The above and other objects are accomplished in accordance with the present invention which is directed to a wearable holder for a writing instrument or the like comprising a slidable clip member adapted to attach to a user's clothing, and a writing instrument holding means for releasably holding a pen or the like, secured to the slidable clip member. The writing instrument holding means may be rotatably secured to the slidable clip member by means of a freely turning shaft, such as a rivet or a nut and bolt assembly. In use, the slidable clip member may be attached to the user's clothing in various orientations, for example, horizontally or vertically or other, and the freely turning shaft will allow the writing instrument to hang vertically.

In one embodiment, the writing instrument holding means is a generally hollow, open-ended member made of a resilient material, defining a generally cylindrical channel with a longitudinal slit to allow a writing instrument to be inserted and removed. Although, in this embodiment, the writing instrument holding means may be characterized by a generally cylindrical cross-sectional shape, it will be appreciated that other cross-sectional shapes may be employed to adapt the clamp to the cross-sectional shape of a particular instrument. Thus, for example, a clamp having a generally triangular cross-sectional shape might be employed if the wearable holder is intended primarily for use with a particular instrument, such as a pen or pencil having a triangular cross-sectional shape.

The writing instrument holding means may be secured to the slidable clip member in various ways provided it is freely turning in a plane parallel to the outer face of the slidable clip member when the wearable holder is in use. This may be accomplished by securing the writing instrument holding means to the slidable clip member by means of a freely turning shaft such as a rivet. In a preferred embodiment, the shaft may be affixed at the outer end to a disc which is then freely turning in response to the turning of the shaft. The writing instrument holding means is then affixed to the freely turning disc.

In another embodiment the writing instrument holding means may be of the type disclosed in U.S. Pat. No. 5,544,396 wherein a writing instrument is held between two clamp jaws pressed together by spring tension. This type of holding means may be affixed to the freely turning disc and has the advantage that it is capable of holding instruments of different diameters.

Other embodiments of the writing instrument holding means include magnetic attraction or hook and loop fastening means. When magnetic attraction is employed, the freely turning disc may have a magnetic material on the surface thereof and the writing instrument will have a magnetically attractive material, such as iron on at least a portion of its surface. Hook and loop fastening means may be employed as the holding means by applying either the hook or loop component to the outer surface of the freely turning disc and the alternate component to the writing instrument.

The slidable clip can be secured to a garment in a variety of ways. Thus, for example, it can be conveniently clipped into the breast pocket of a shirt, or onto the neck of a high-necked blouse or tee-shirt, or sideways, between the buttons on the front of conventional front-buttoning shirt, or at the edge of the neck opening of a V-necked shirt or onto a belt as well as at various other locations on the user's clothing. In a particular embodiment, the slidable clip may include means to attach a lanyard or necklace or the like so that the wearable holder may be worn around the user's neck. This may be accomplished by providing one or more holes at a suitable location in the clip and lacing a lanyard or necklace through the hole(s) or attaching each end of the lanyard to a hole in the slidable clip. In a preferred embodiment the slidable clip includes two holes, each for the attachment of a separate end of a lanyard. Preferably the two holes are positioned at the open end of the slidable clip (in the manner shown in FIG. 2). In this embodiment, the slidable clip can be used either in a pendant fashion, as shown in FIG. 9, or as a slidable clip on a garment as illustrated in FIGS. 1 and 5. In the latter instance, when the slidable clip is in position on a wearer's clothing, the holes, which in this instance are non-functioning, are hidden from view.

### BRIEF DESCRIPTION OF SEVERAL VIEWS OF THE DRAWING

The present invention and the manner in which it may be practiced is further illustrated with reference to the accompanying drawings wherein:

FIG. 1 shows a front perspective view of a tee shirt with the wearable holder of the invention clipped at the neck thereof.

FIG. 2 shows a front view of a wearable holder of the present invention, holding a writing instrument.

FIG. 3 shows a side cross-sectional view of the embodiment of the wearable holder shown in FIG. 3 (without a writing instrument in place).

FIG. 4 shows a top view of the wearable holder depicted in FIG. 2.

FIG. 4A shows a top view of a wearable holder of the invention with an alternate embodiment of the writing instrument holding means.

FIG. 4B shows a top view of a wearable holder of the invention with a different embodiment of the writing instrument holding means.

FIG. 5 shows a front perspective view of a buttoned shirt with a wearable holder of the invention clipped thereto.

FIG. 6 shows a front view of a wearable holder for pens and the like utilizing a prior art spring loaded writing instrument holding means holding a writing instrument.

FIG. 7 shows an exploded perspective view of an embodiment of a wearable holder for pens and the like in accordance with the invention.

FIGS. 8A-B show a wearable holder of the invention utilizing alternate embodiments of the holding means and a writing instrument adapted for use therewith.

FIG. 9 shows a wearable holder of the invention adapted for wearing pendant style.

### DETAILED DESCRIPTION OF THE INVENTION

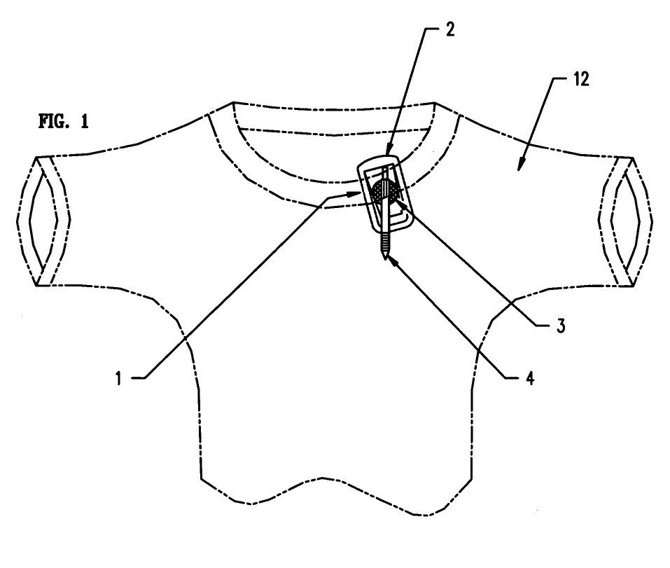

The wearable holder 1 of the present invention, as illustrated in FIGS. 1-9, includes a slidable clip member 2, adapted to attach to a user's clothing, and a writing instrument holding means 3 secured thereto for releasably holding a pen or the like. In FIG. 1, wearable holder 1 is attached to a user's tee shirt by means of slidable clip member 2 clipped onto the neck of the tee shirt 12. A writing instrument 4 is removably held in writing instrument holding means 3.

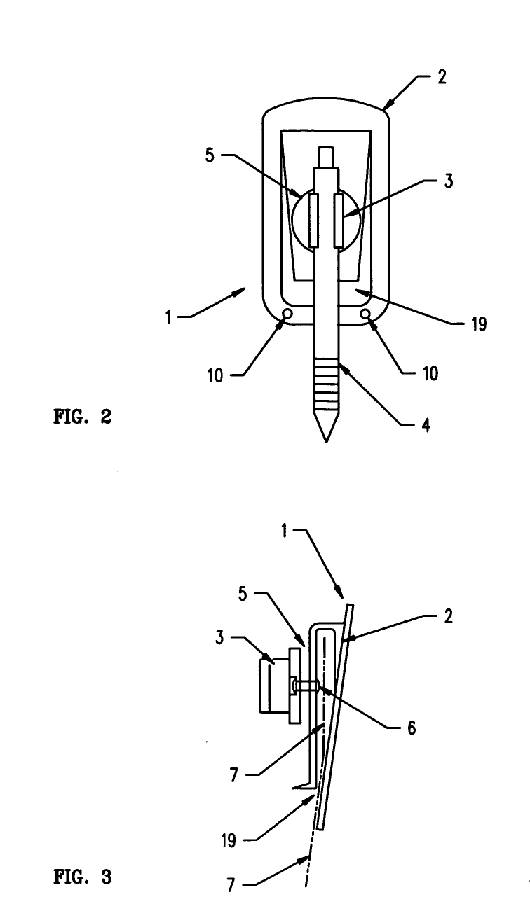

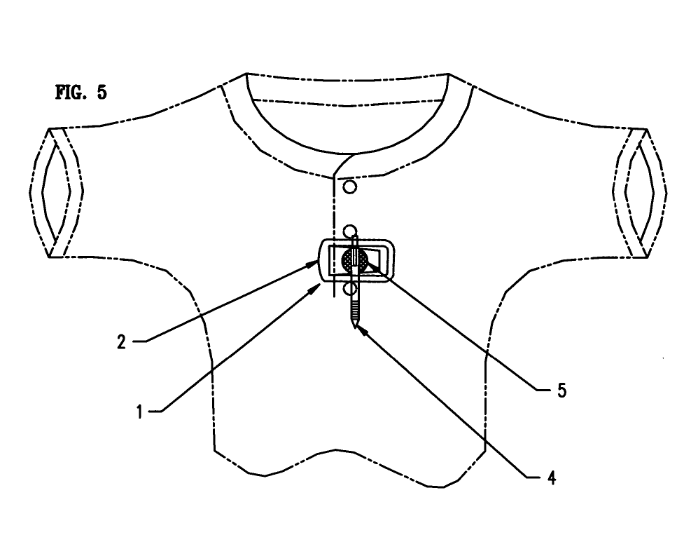

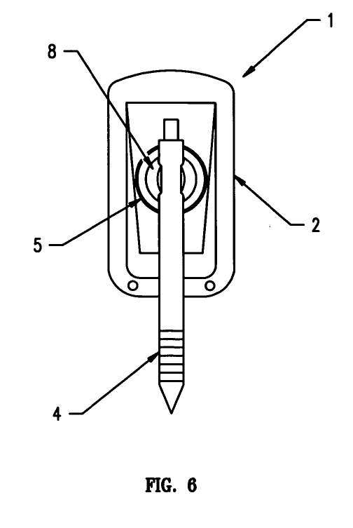

In FIG. 2, the wearable holder 1 includes a slidable clip member 2 having affixed thereto a free turning disc 5 by means of a turnable rivet 6 (not shown in FIG. 2). Writing instrument holding means 3 may be affixed to free turning disc 5 in various ways, such as by adhesive, or rivet, or nut and bolt or the like, or by soldering if both parts are of a suitable metal. The writing instrument holding means 3 may be in the form of a clip, as shown, made from a metal, such as a spring steel, or resilient plastic, so that writing instrument 4 may be conveniently pressed into the clip and held therein until removed. The open end 19 of slidable clip 2, shown in FIGS. 2 and 3 can be conveniently slid over a garment cloth 7 to maintain the wearable holder 1 in a convenient location on the user's clothing as shown in FIGS. 1 and 3. Further more, in a preferred embodiment, the slidable clip member 2 of FIG. 2 is provided with holes 10 for use as attachment points for a lanyard connection to allow the wearable holder 1 to be worn either clipped to a garment as shown in FIGS. 1 and 5 or in a pendant style in the manner depicted in FIG. 9. Most preferably, holes 10 are located near the open end 19 so that they will not normally be in view when the wearable holder 1 is clipped onto a garment as in FIGS. 1 and 5.

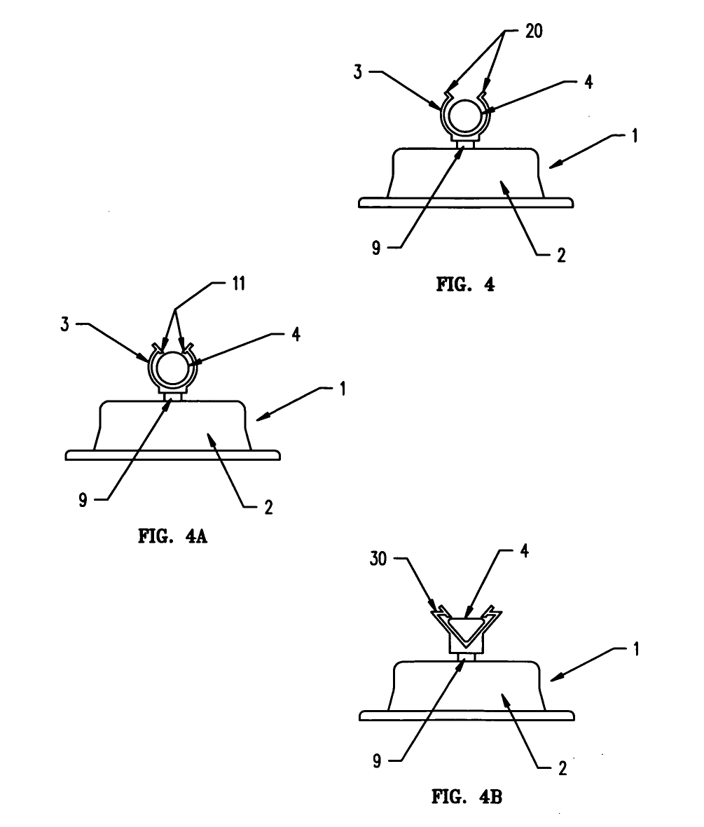

The embodiment of wearable holder 1 of FIGS. 2 and 3 is shown in FIG. 4 in a top view that is, from the closed end of the slidable clip member 2. Writing instrument 4 is removably held in holding means 3. Outer tabs 20 on the clip of holding means 3 serve as a guide, making the placement of writing instrument 4 into the holding means easier. When the writing instrument is in place, the freely turning shaft 9 allows the writing instrument 4, in response to the force of gravity, to orient to a vertical position, regardless of the orientation of the wearable holder 1. This advantageous feature is further illustrated by a comparison of FIGS. 1 and 5 wherein, despite a 90° difference in the orientation of the wearable holder 1, writing instrument 4 remains in a vertical orientation.

FIGS. 4A and 4B show, in top view, wearable holders with different embodiments of the “clip type” writing instrument holding means of FIG. 4. In FIG. 4A, writing instrument holding means 3A is provided with inner tabs 11, which serve to hold writing instrument 4 more securely. In FIG. 4B, writing instrument holding means 3B is designed to hold and conform to a writing instrument 4B having a triangular cross-sectional shape.

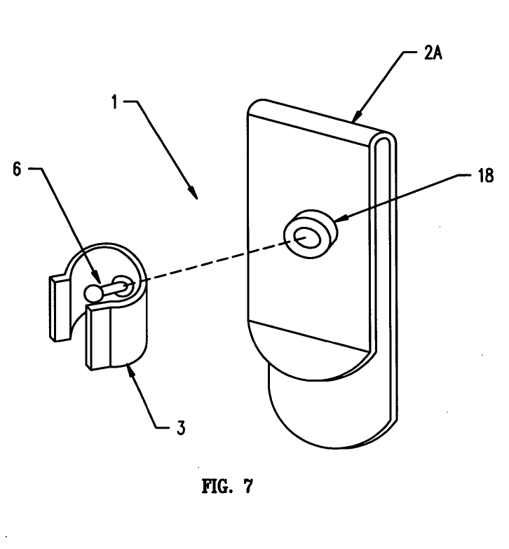

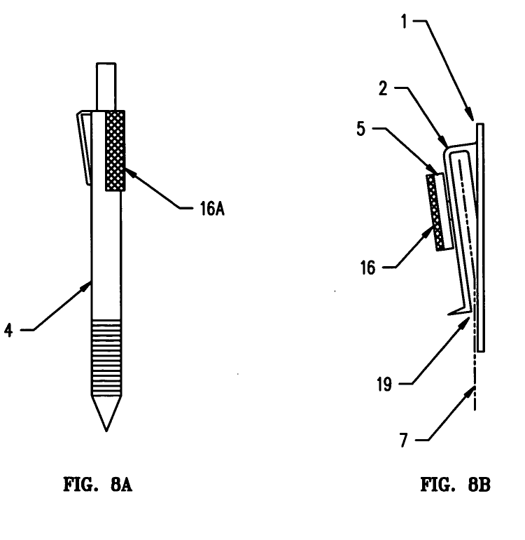

In the embodiment of FIG. 6, the writing instrument holding means 8 is a spring loaded clamp holder of a type normally used for holding an instrument such as a pen or pencil on a stationary object. The holder is described in detail in U.S. Pat. No. 5,544,396, the details of which are incorporated herein by reference. In the present invention, the spring loaded clamp holder is affixed to a free turning disc 5 which, in turn is rotatably attached to slidable clip member 2 so that, in use, for example when slidable clip member 2 is attached to the user's clothing, writing instrument 4, under the influence of gravity, will assume a vertical orientation.

FIG. 7 is an exploded view of wearable holder 1 showing an alternate embodiment of the sliding clip member. In the drawing, writing instrument holding means 3 is rotatably attached to slidable clip member 2A by rivet 6. (Alternatively a nut and bolt, screw, or other equivalent means may be used for attachment.) In sliding clip member 2A, raised shoulder 16 provides a recess for a rivet head (not shown). In the embodiment of FIG. 7, sliding clip member 2 is preferably made of spring steel.

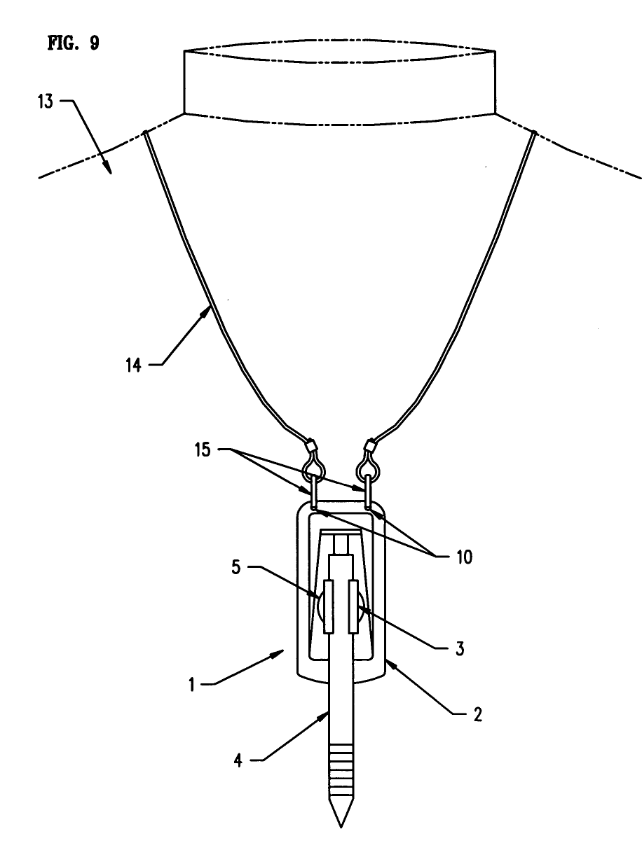

FIGS. 8A-8B depict alternate embodiments with respect to the means for holding a writing instrument onto the slidable clip member 2. FIG. 8A shows a side cross-sectional view of wearable holder 1, comprising a slidable clip member 2 clipped to a cloth garment 7. The slidable clip member 2 has affixed thereto a free turning disc 5 having on the face thereof, an attachment material 16. Writing instrument 4 (FIG. 8A) has affixed thereto, a mating attachment material 16A suitable for holding on attachment material 16. Thus, if material 16 is a magnet, material 16A will be a magnetic material, such as iron, cobalt, nickel, or the like, or a suitably magnetic alloy. It will be understood that the materials may be reversed and material 16 A may be a permanent magnet and material 16 may be a magnetic material so that in either instance the two materials will be held together by magnetic attraction. Similarly, hook and loop materials may be employed as the attachment material with hook material on one and loop material on the other.

FIG. 9 depicts the use of the wearable holder of the invention in a pendant style attached to a lanyard or necklace worn around the neck of the user. In the drawing, wearable holder 1 is attached by means of holes 10 and attachment rings 15 to lanyard 14 worn around the neck of a user's blouse or shirt 13. When worn in this manner, the orientation of the wearable holder 1 is turned 180° from that shown in FIG. 2. However, because of the free turning disc 5, the writing instrument 4 is maintained in a vertical orientation, pointing downward.

The components of the wearable holder of the invention, that is, the slidable clip member 2, the writing instrument holding means 3, and the free turning disc 5, may be fabricated in a known manner from various materials, such as, resilient moldable plastic, or metal, preferably spring steel.

Although the invention has been described with reference to certain embodiments thereof, it will be appreciated by those skilled in the art that modifications and variations may be made without departing from the spirit and scope of the invention as defined in the claims set forth below.

What I claim as my invention:

1: A wearable holder for a writing instrument comprising a slidable clip member having an open end and a closed end, adapted to slidably attach to a user's clothing, and a writing instrument holding means for releasably holding a writing instrument rotatably secured to said slidable clip member, to permit said writing instrument holding means holding said writing instrument to rotate freely in a plane generally parallel to said slidable clip member.

2: A wearable holder for a writing instrument according to claim 1 wherein said writing instrument holding means is of a resilient material defining a channel, open at each end, and having a longitudinal slit therein that allows said slit to spread when a writing instrument is pressed into said slit and then retract to removably hold said writing instrument in place.

3: A wearable holder for a writing instrument according to claim 2 wherein said writing instrument holding means defines a generally cylindrical channel.

4: A wearable holder for a writing instrument according to claim 2 wherein said writing instrument holding means defines a channel of generally triangular cross-sectional shape.

5: A wearable holder for a writing instrument according to claim 1 wherein said slidable clip member includes a means for attaching said slidable clip member as a pendant for wearing about a user's neck.

6: A wearable holder for a writing instrument according to claim 5 wherein said slidable clip members includes two holes suitable for attaching said slidable clip member as a pendant.

7: A wearable holder according to claim 6 wherein said two holes are positioned at said open end of said slidable clip member.

8: A wearable holder for a writing instrument according to claim 1 wherein said writing instrument holding means is affixed to a freely turning disc which, in turn is rotatably secured to said slidable clip member to permit said freely turning disc and said writing instrument holding means affixed thereto to rotate freely in a plane generally parallel to said slidable clip member.

9: A wearable holder for a writing instrument according to claim 8 wherein said writing instrument holding means is a spring loaded clamp.

10: A wearable holder for a writing instrument according to claim 8 wherein said writing instrument holding means is a magnetic material affixed to the surface of said freely turning disc and said writing instrument includes a material capable of being magnetically attracted and removably held by said magnetic material.

11: A wearable holder for a writing instrument according to claim 8 wherein said writing instrument holding means is a hook and loop fastener wherein one component of said hook and loop fastener is affixed on a surface of said freely turning disc and another component is affixed to said writing instrument.
